(19) United States
(12) Patent Application Publication
(10) Pub. No.: US 2020/0299024 A1
(43) Pub. Date: Sep. 24, 2020

(54) Packaging

(71) Applicant: Dmitrii Viktorovich SAVELEV, Moscow (RU)

(72) Inventor: Dmitrii Viktorovich SAVELEV, Moscow (RU)

(21) Appl. No.: 16/645,731

(22) PCT Filed: Sep. 12, 2019
(86) PCT No.: PCT/RU19/00631

§ 371 Date: Mar. 9, 2020

(30) Foreign Application Priority Data
Aug. 15, 2018 (RU) 2018129756

(51) Int. Cl. B65D 5/42; B65D 5/40; B65D 65/40; B65D 25/14; B65D 65/46

(52) U.S. Cl. CPC B65D 5/4279; B65D 5/40; B65D 65/466; B65D 25/14; B65D 65/40

(57) ABSTRACT

The proposed product relates to the field of manufacturing packaging for primarily liquid, fatty, and frozen food products or for products that contain or release fats and moisture. The present packaging, having an overlapping seam with a sealed end face, is made of a shape-giving material that consists of a base material and a protective layer applied on one side of said base material. The protective layer is elongated relative to the base material, and at the place where the shape-giving material is joined in an overlapping fashion to form a seam, the elongated protective layer is connected on the inner side of the packaging to the adjoining layer of shape-giving material without the protective layer coming into contact with the end face surface of the shape-giving material, to protect an end face without thickening the material at an overlap point and without the overlap point being excessively rigid, as well as without using an additional protective polymer tape or an expensive base material having hydrophobic properties.

### CROSS-REFERENCE TO RELATED APPLICATIONS

This application is a U.S. national phase application of an international application PCT/RU2019/000631 filed on 12 Sep. 2019, whose disclosure is incorporated herein in its entirety by reference, which international application claims priority of a Russian Federation patent application RU2018129756 filed on 15 Aug. 2018, now Pat. No. RU189037.

### FIELD OF THE INVENTION

The invention refers to the production of packaging for mainly liquid, fatty and frozen foodstuffs or products containing or releasing fats and moisture.

### BACKGROUND OF THE INVENTION

The most known types of packaging where the claimed invention may be used are paper cups, various containers with round or other bases, packages of various shapes for dairy products, juices and other products where the main forming/frame material is mainly pulp and paper material or any other material requiring protection of the end-face from contact with the contents of the container.

When forming a container, where laminated pulp and paper material are mainly used as the frame material, as well as any other material, that requires protection of the end-face from contact with the contents of the container, there is a problem when, when the material overlap at the joint. The end face at the inner surface without the use of additional methods of protection is unprotected from contact with the contents of the container.

There are several ways to solve this problem:
1. Bending and turning the end face under itself.
2. Application on the end face or in the area of its location of the polymer tape.
3. Use of material with high end-face absorption resistance.

In revealing each of the methods used to date to address the problem of end-face absorption, it is necessary to pay attention to the obvious shortcomings of each of them.

The method of bending or turning under is mainly used in the production of packaging for dairy products and juices. Requires special folding equipment. Due to the increase in the number of layers up to three at the welding/adhesive point at the container walls, the seam has an excessive compaction, which imposes some restrictions on the formation of cups and containers with a round base and a rolled edge.

There is a widely used way to compensate for the excess thickness of the three layers by trimming the bendable edge of the workpiece to reduce the thickness of the tilted edge. However, as a rule, due to the heterogeneity of the material structure in terms of thickness, physical and technical properties of the folded material in the place of bending, it is not possible to keep the same properties comparing to the material bound in one layer without a fold.

Application to the end of the polymer tape. It is a method of end-face protection used by Tetrapack® in the production of packaging for liquid products. It is a method based on the application of an additional special multi-layer material in the form of a polymeric strip with a reduced elasticity for its application. This method has a significant limitation—it is used to process the web fed material before it is divided into single workpieces. Thus, this method has a limitation in the formation of pre-cut products by pieces.

In addition, as with the previous method, it creates an excessive seam thickness and completely different physical and technical properties compared to the same properties of the material bonded in one layer without additional layers of other materials.

Use of material with high end-face absorption resistance. This method is most widely used in the production of paper cups and containers for food products with a round base, as well as in the production of milk bags and juices with a short shelf life. It is based on the use of pulp and paper raw materials with hydrophobic additives that slow down or prevent long time penetration of liquid, greasy and other products into the end-face part of the material in contact with the contents of the package.

This method does not imply any protection of the end-face by additional methods at all, but is based solely on the properties of the material itself in terms of resistance to end-face absorption.

The main disadvantages of this method are the higher cost of pulp and paper base material, which has the mentioned properties, as well as the impossibility of long-term storage of the product due to direct contact of the food product with the microbiological environment of the end-face of the pulp and paper material.

The main drawbacks in the applied end-face protection methods described and not inherent by this invention are:

1 Excessive thickening of the material at the overlap and end-face protection of the frame material (observed both when bending or turning under the material and when applying polymeric tape). It also complicates further assembly and formation of the finished package.

2. Excessive rigidity of the overlap and end-face protection of the forming/frame material (especially when bending or turning under the material). Complicates further assembly and formation of the finished package. Especially it prevents high-quality rolling of the upper edge of paper cups and round containers.

3. In the case of polymer tape application, the method is known to be used in the course of processing the web fed material before it is divided into single workpieces. Thus, the method of application of polymeric tape has a significant limitation when working with pre-cut products by single pieces.

4 Use of expensive frame material with hydrophobic properties in case of absence of additional methods of face-end protection.

There is a known multi-layer packaging material for a flexible, preferably pillow-shaped packaging container containing an inner paper layer, external liquid-tight layers of polyolefin on both sides of the paper layer, and aluminum foil, which serves as a gas-tight layer and is located between the paper layer and one of the two outer liquid-tight layers. Between the aluminium foil and one of the two external liquid-tight layers, it contains a load-absorbing polyolefin film in contact with the aluminium foil. Foldings of packaging material are formed by means of heat sealing (patent RU Nº 22529522 27.09.2014).

There is a known packaging container, taken as a prototype containing a multilayer forming material consisting of frame and protective layers. The protective layer is contained on the outer and inner surface of the frame material (patent RU Nº 2487065 from 10.07.2013).

However, the difficulty in assembling the known technical solutions due to the multi-layer structure of the material and the way of forming folds, entails a thickening of the material in the places of seams and, as a consequence, the provision of excessive rigidity of packaging, i.e. complication of further assembly and formation of the finished package.

### SUMMARY OF THE INVENTION

The problem to be solved by the present invention is to simplify the assembly and formation of a finished package, for achieving a result of protection of the end-face of forming material without thickening the forming material in the place of overlap (seam).

The above stated result is achieved in the claimed package with a sealed end-face of the seam overlapping made of the forming material (consisting of a frame material and a protective layer) which is applied only from the inner side of the frame material, the protective layer is extended relative to the transverse length of the frame material by means of an elongated protective layer, and, at the point where the forming material is joined by overlaps to form a package seam, the elongated protective layer is connected to a mating layer of the forming material without touching the end-face of the seam.

An additional feature is that the protective layer is made of biodegradable polymer, e.g. polymlactic acid (PLA).

The main idea of this invention is to extend the protective layer beyond the frame material and its subsequent soldering to the protective layer of the mating surface during the formation of the finished package so that the protected end-face of the frame material remains isolated from contact with the food contents of the package.

Extending the protective layer beyond the frame material does not cause thickening of the material at the place of heat sealing with the mating surfaces, as in the conventional case with the imposition of additional polymeric tapes or in some cases of material patching, or changes in technical and mechanical properties, as in the case of bending or patching the material.

### DRAWINGS OF THE INVENTION

FIG. 1 schematically depicts conventionally known elements of packaging with a protective layer having an unprotected end-face edge;

FIG. 2 schematically depicts a conventionally known method contemplating a bending pattern with compensation for excess layer thickness by trimming the bending edge of the frame material;

FIG. 3 schematically depicts a conventionally known method contemplating application of a polymer tape around the end-face (seam) of the frame material, to protect the end face;

FIG. 4 schematically depicts a conventionally known method contemplating application of a polymer tape partially around the end-face of the frame material and partially along an inner surface of the protective layer, to protect the end face;

FIG. 5 schematically depicts a preferred embodiment of the invention contemplating application of an elongated protective layer of a polymer tape to a mating surface of the frame material, to protect the end face.

### DESCRIPTION OF KNOWN METHODS VERSUS PREFERRED EMBODIMENT OF THE INVENTION

The proposed protection of the end-face of the forming material by extending the protective (lamination) layer and further heat sealing with the adjacent layer during the formation of a packaging container is explained in the attached drawings wherein:
1—protective layer;
2—frame material;
3—polymer tape;
4—elongated protective layer;
5—insulated protected end-face of the frame material.

FIG. 1 shows the general characteristics of the problem. When forming a frame package coated/laminated with a protective layer on the inner surface of the package, the bonding of the material creates an unprotected end-face edge (unprotected end-face), which then comes into contact with the contents of the package.

It is also the most commonly used side wall mounting scheme for forming paper cups and food containers with a round base. At their manufacturing the frame material with high indicators of obstruction of end-face absorption is most often used.

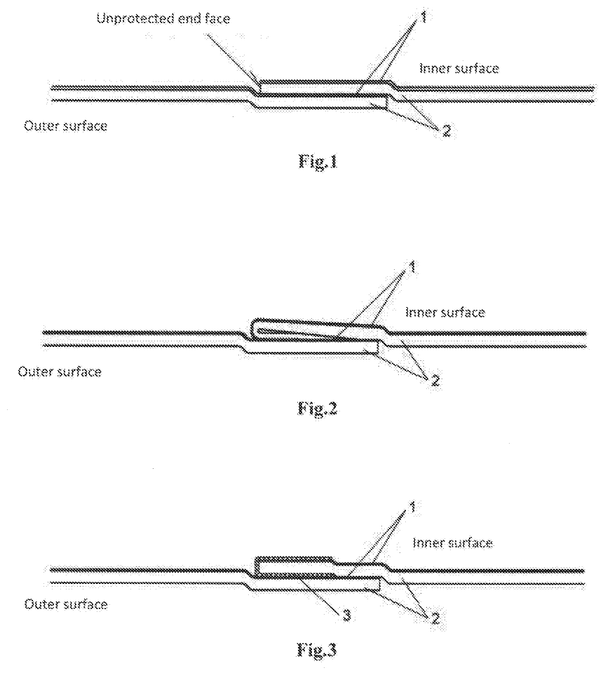

FIG. 2 shows a bending or reversal pattern with compensation for excess layer thickness by trimming the bending edge of the workpiece.

Due to the increase in the number of layers up to three at the welding/gluing point of the packing walls, the seam has an excessive compaction, which imposes some restrictions on the formation of glasses and containers with a round base and a rolled edge.

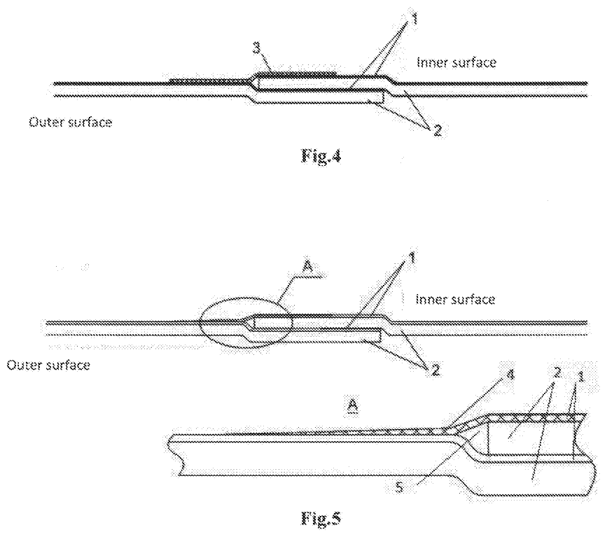

FIGS. 3 and 4 show a polymer tape application scheme to protect the end-face of the frame material. It is a method of end-face protection used in the production of packaging for liquid products. The method is based on the application of an additional, specially multi-layer material in the form of a polymeric tape with reduced elasticity for the possibility of its application. This method has a significant limitation: it is used to process the web fed material/workpiece before it is divided into single products.

This method of protecting the end-face of the frame material creates an excessive thickness of the seam, which may impose restrictions on the types and methods of formation of packaging.

FIG. 5 schematically shows a preferred embodiment of the claimed invention, wherein no excess thickness is created in the place of fastening mating surfaces of a frame material and a protective layer, no additional materials are introduced (as in the case of a fold), and the direction of the frame material fibers is not changed, which, in the conventionally known methods, changes the local physical and mechanical characteristics of the frame material in the place of seam and may impose restrictions when rolling an edge of the package, or during further formation of the package.

The forming material of the container consists of a frame material 2 and a protective layer 1, applied from the inner side of the frame material 2, thereby forming an end-face 5 of the frame material. The protective layer 1 is extended by means of an elongated protective layer 4 in relation to the frame material 2 and, at the point where the forming material overlaps to form a seam, the elongated protective layer 4 is connected to a mating layer of the forming material. In this way, the end-face 5 of the frame material 2 is sealed by covering the end-face 5 with the elongated protective layer 4, without thickening the forming material.

Further production of containers (packaging) is carried out in a conventional way with the selection of appropriate tools and welding modes of the frame material 2. Together with the welding of the frame material 2, the elongated protective layer 4 is welded to the mating surface to protect the welded area from contact with the external environment (e.g. the contents of the container) and to protect the end-face 5 of the frame material from contact with the contents of the container or the external environment.

1. Packaging with a sealed lapped end-face of the seam made of a forming material consisting of a frame material and a protective layer, which is distinguished by the fact that the protective layer is applied only from the inner side of the frame material, is made of elongated relative to the transverse length of the frame material, and at the point where the forming material overlaps to form the package seam, the elongated protective layer is connected to the mating layer of the forming material, without contact with the end-face of the seam.

2. Packaging according to item 1, which differs in the fact that the protective layer is made of biodegradable polymer.
